(19) United States
(12) Patent Application Publication
(10) Pub. No.: US 2012/0017504 A1
(43) Pub. Date: Jan. 26, 2012

(54) LONG-TERM NO-WATERING FLOWERPOT

(76) Inventor: Tsung-Peng Lin, Douliu City (TW)

(21) Appl. No.: 12/841,177

(22) Filed: Jul. 22, 2010

(51) Int. Cl. A01G 9/02

(52) U.S. Cl. 47/65.5

(57) ABSTRACT

A long-term no-watering flowerpot includes a main body having a lower portion formed as a water groove. At least a water exit is bored in a circumferential wall of the main body above the water groove. The water groove can store extra water. By means of capillarity, water in the water groove can be sucked up to moisturize the soil in the flowerpot for the plant to absorb. Thus watering cycle can be prolonged to save manpower and water resource.

### BACKGROUND OF THE INVENTION

1. Field of the Invention

This invention relates to a long-term no-watering flowerpot, particularly to one having a water groove formed in the lower portion of a main body so that, by capillarity of soil, water in the water groove can be sucked up to wet the soil for a plant to absorb for a long period of time.

2. Description of the Prior Art

Commonly, as shown in FIG. 1, conventional flowerpots 1 used to grow flowers and plants in urban houses includes a main body 10 and at least a water exit 11, with soil 12 filled in the main body 10 for being planted with plants 13. When the flowerpot 1 is watered to make the soil 12 wetted to supply water for the plant 13, extra water is to drain out through the water exit 11. As water cannot be stored in the main body 10, the plant 13 in the main body 10 has to be frequently watered so as to prevent it from withering. up So the conventional flowerpot 1 has disadvantages as mentioned below.

1. Water is to immediately run out of the main body 1 through the water exit 11 while watering the plant 13, posing a waste of water resource.

2. As only little water can be kept by the soil 12, it is to quickly be consumed by the plant 13 and evaporate owing to sunshine and wind flowing. The growth of the plant 13 would be retarded if short of water.

3. The plant 13 has to be frequently watered due to a short cycle of watering, subject to needing extra manpower and wasting water resource.

4. As the water exit 11 is located in the bottom of the main body 10, it could be flooded by rain unable to exhaust out of the main body 10 in due time, making the roots of the plant 13 emerged in water to get decayed, even possible to pose death of the plant 13.

5. If the plant 13 is weakly resistant to drought and not watered in time, its growth can easily be retarded.

### SUMMARY OF THE INVENTION

The object of this invention is to offer a flowerpot having the lower portion utilized to store extra water, so that the soil can be steadily moisturized to prolong watering cycle.

The main characteristics of the invention are a main body, a water groove formed in the lower portion of the main body, and at least a vertical water exit formed in the intermediate wall of the main body above the water groove.

### BRIEF DESCRIPTION OF DRAWINGS

This invention is better understood by referring to the accompanying drawings, wherein:

FIG. 1 is an illustrating view of a conventional flowerpot, showing it being planted with a plant;

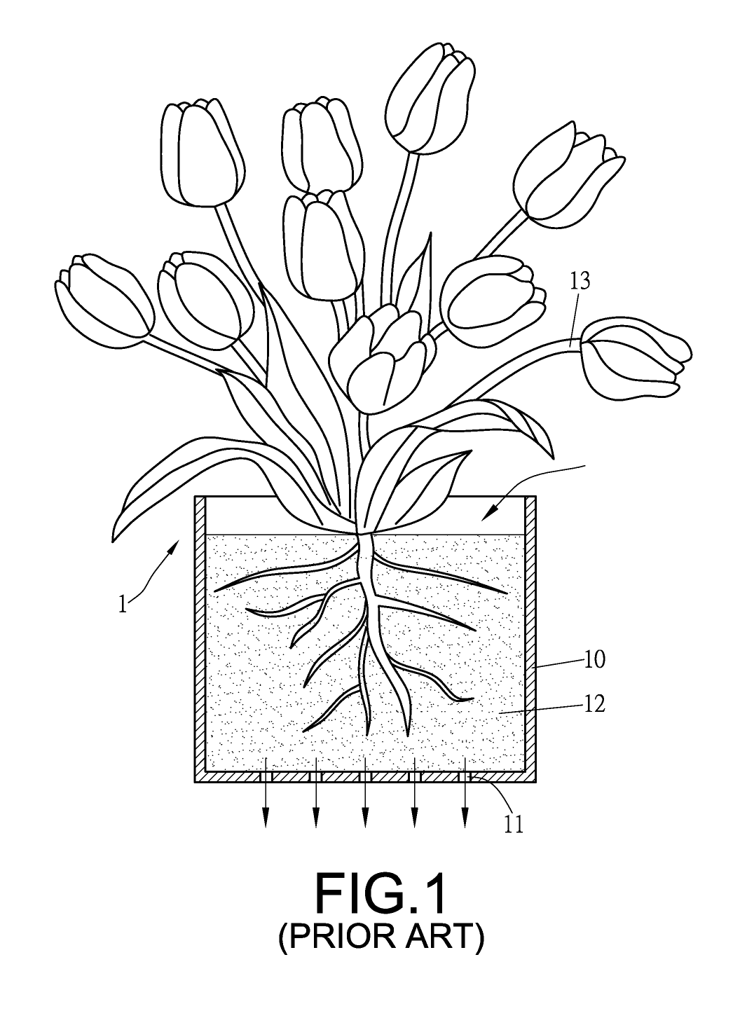

FIG. 2 is a cross-sectional view of a preferred embodiment of a long-term no-watering flowerpot in the present invention; and

FIG. 3 is an illustrating view of the preferred embodiment of a long-term no-watering flowerpot in the present invention, showing it being planted with a plant.

### DETAILED DESCRIPTION OF THE PREFERRED EMBODIMENT

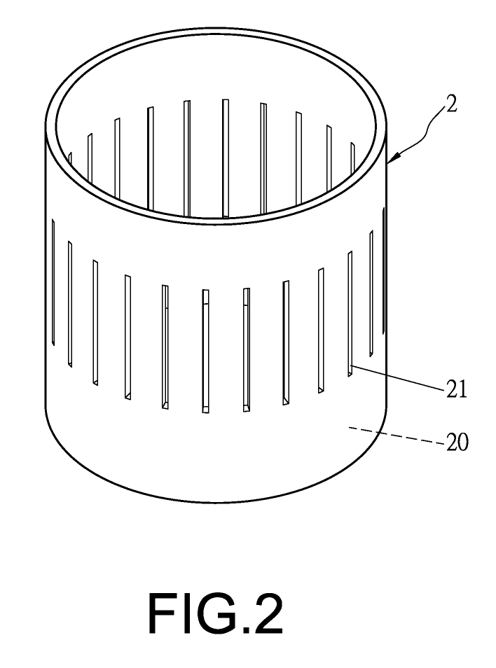

As shown in FIG. 2, a preferred embodiment of a long-term no-watering flowerpot in the present invention includes a main body 2, whose lower portion is formed as a water groove 20. A plurality of vertical water exits 21 are cut equidistantly spaced apart around the intermediate circumferential wall of the main body 2 equidistantly spaced apart.

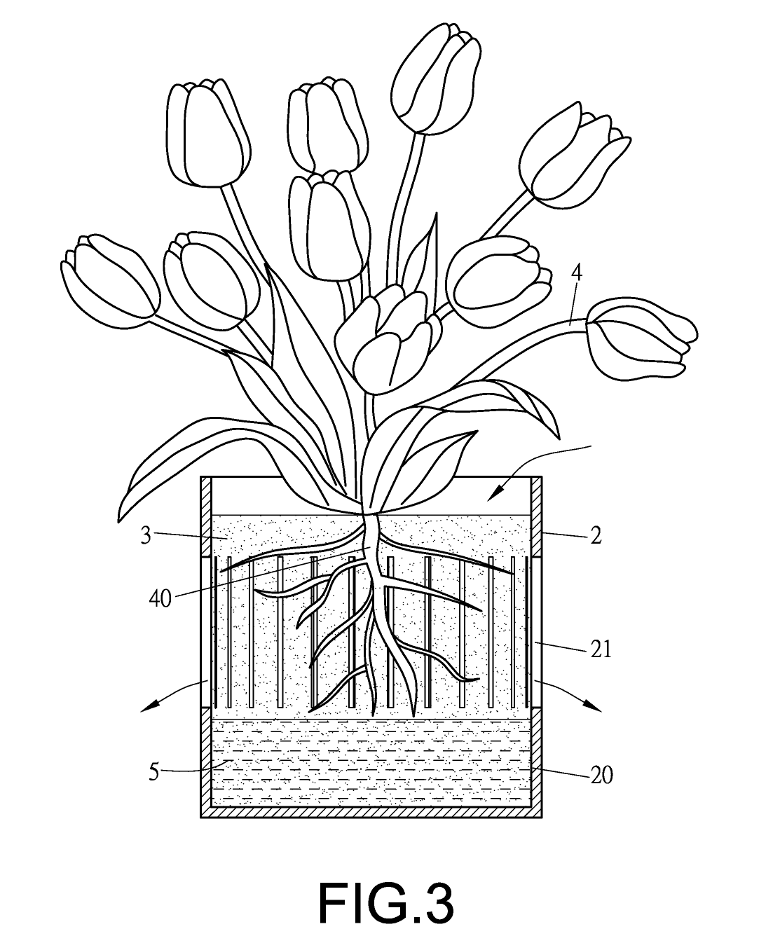

In using, as shown in FIGS. 2 and 3, the main body 2 is first filled with soil 3. Then a plant 4 is planted in the soil 3 in the upper portion of the main body 2, with roots 40 buried above the water groove 20. When the plant 4 is watered, water is to be primarily absorbed by the soil 3 and the roots 40, with the extra quantity of water remained in the water groove 20 so as to save water resource. If extra water or rain runs into the main body 2 over the water groove 20, it is to be exhausted through the water exits 21 in the wall of the main body 2, able to prevent the roots 40 from being soaked in water. Moreover, the roots 40 can contact with air through the water exits 21 so that the plant 4 can grow better. As the moisture of the soil 3 is gradually absorbed by the roots 40 of the plant 4 and evaporated by sunlight, water 5 in the water groove 20 can be sucked up to wet the soil 3 due to capillarity, enabling the plant 4 supplied with water continually for a long time. And because the water exits 21 have a higher level than the ground in case of putting the flowerpot on the ground, rain on the ground can not block the water exits 21 from exhausting water, so that the roots 40 are not to be soaked in water to deteriorate the growth of the plant 4.

The invention has the following advantages as can be seen from the foresaid description.

1. With the water groove 20 to store extra water, water resource can be sufficiently used without wasting.

2. By means of capillarity, the water in the water groove 20 can be sucked up to properly moisturize the soil 3 so as to benefit the growth of the plant 4.

3. Watering cycle can be effectively prolonged to save manpower and water resource.

4. The water in the water groove 20 is helpful in preventing drought.

5. As the water exits 21 are located in the intermediate wall of the main body 2 with a level higher than the ground, they are not to be affected by rain for water to flow out.

6. With the water exits 21 formed in the wall of the main body 2, the roots 40 can easily contact with air to benefit the growth of the plant 4.

7. Fertilizers can effectively remain in the water groove 20 after watering the plant 4.

While the preferred embodiment of the invention has been described above, it will be recognized and understood that various modifications may be made therein and the appended claims are intended to cover all such modifications that may fall within the spirit and scope of the invention.

1. A long-term no-watering flowerpot comprising a main body having a lower portion formed as a water groove, at least a water exit cut in a circumferential wall of said main body above said water groove.
